(19) United States
(12) Patent Application Publication
(10) Pub. No.: US 2009/0043414 A1
(43) Pub. Date: Feb. 12, 2009

(54) METHOD FOR DETERMINING ARRANGEMENT OF PRODUCTION EQUIPMENT

(76) Inventor: Yasuhiro Maenishi, Saga (JP)

Correspondence Address: WENDEROTH, LIND & PONACK L.L.P., 2033 K. STREET, NW, SUITE 800, WASHINGTON, DC, 20006, US

(21) Appl. No.: 11/914,414

(22) PCT Filed: Apr. 26, 2006
(86) PCT No.: PCT/JP2006/308776

§ 371 Date: Nov. 14, 2007

(30) Foreign Application Priority Data
May 30, 2005 (JP) 2005-157249

(51) Int. Cl. G06F 19/00

(52) U.S. Cl. 700/101; 700/97

(57) ABSTRACT

In a method for determining arrangement of production equipment that can determine component arrangement positions in a component mounting apparatus so as to reduce as much as possible the workload of an operator that exchanges components and the like, the number of pickup nozzles of a line gang pickup head provided in each of two sub-equipment is checked (S11). Then, based on the ratio of the numbers of pickup nozzles of the two line gang pickup heads checked in the processing S11, the component cassettes for the components of component types described in number-of-mounting-points information are assigned to two component supply units (S12). The arrangement positions for the components assigned in the processing S12 are exchanged between the two component supply units, so that components having a larger number of mounting points (the number of components) are arranged on the inner side of the electronic component mounting system (S13).

### TECHNICAL FIELD

The present invention relates to a method for determining arrangement of production equipment and, in particular, to a method for determining arrangement of production equipment, used when the production equipment is a component mounting apparatus that mounts electronic components onto a board.

### BACKGROUND ART

In the conventional art, various optimization methods have been proposed for a mounting order in component mounting onto a board performed by a component mounting apparatus. In some of these optimization methods for a mounting order, the mounting order is optimized such that the production time per board (tact time) is reduced (see, for example, Patent Reference 1).

### Patent Reference 1: Japanese Laid-Open Patent Publication No. 2002-50900

### DISCLOSURE OF INVENTION

### Problems that Invention is to Solve

However, monitoring and management of components distant from the operator position is difficult even when the mounting order for the components is determined by prioritizing the tact time. Thus, for example, when components run out and so on, component exchange takes a long time. This causes a problem that even when the mounting order is optimized by prioritizing the tact time, the effect of the optimization will not easily be obtained.

The present invention has been devised in order to resolve the above-mentioned problem. An object of the present invention is to provide a method for determining arrangement of production equipment that can determine component arrangement positions in a component mounting apparatus so as to reduce as much as possible the workload of an operator that exchanges components and the like.

### Means to Solve the Problems

In order to achieve the above object, a method for determining arrangement of production equipment according to the present invention is a method for determining arrangement of production equipment used in a production equipment arrangement determining apparatus which determines arrangement of a production equipment that produces a component mounting board which is a board onto which components are mounted. The method includes: a determining step of determining a face where an operator mainly operates the production equipment, depending on a deployment position of the operator, the determining step being performed by the production equipment arrangement determining apparatus.

According to this configuration, the arrangement of the production equipment can be determined such that the face where the operator mainly operates the production equipment is oriented to the operator side. Thus, the efficiency of operating the production equipment is improved. In particular, when the main function of the production equipment is exchanging components, component arrangement positions to the component mounting apparatus can be determined such that load to the operator in component exchange and the like is reduced as much as possible.

For example, the production equipment is a component mounting apparatus which includes a plurality of component supply units and which mounts the components onto the board. In the determining step, arrangement positions of component cassettes with respect to the component supply units are determined depending on the position where the operator is deployed, the component cassettes containing the components.

According to this configuration, arrangement positions for the component cassettes can be determined such that the operator's working efficiency is improved. This allows the component exchange work to be performed rapidly by the operator, and hence improves the efficiency of the component exchange work performed by the operator.

Preferably, in the determining step, the arrangement positions of the component cassettes are determined in such a way that a component cassette for components having a relatively larger number of mounting points is arranged in one of the component supply units which is on the side where the operator is deployed.

Further preferably, the component mounting apparatus is an apparatus which includes a plurality of mounting heads that alternately mount components onto one board, and each of the plurality of component supply units is provided in the component mounting apparatus to correspond to one of the plurality of mounting heads. The determining step includes: a number-of-pickup-nozzles acquiring step of acquiring the number of pickup nozzles, which pick up the components, provided in each of the plurality of mounting heads, the number-of-pickup-nozzles acquiring step being performed by the production equipment arrangement determining apparatus; an allocation step of allocating the component cassettes for to-be-mounted components to any of the plurality of component supply units in such a way that a ratio of the number of the pickup nozzles is equal to a ratio of the number of mounting points of the components onto the board, the allocation step being performed by the production equipment arrangement determining apparatus; and an arrangement position determining step of determining, by exchanging the component cassettes between the plurality of component supply units, the arrangement positions of the component cassettes in such a way that a ratio of the number of the pickup nozzles is equal to a ratio of the number of the mounting points of components onto the board, and in such a way that a component cassette for components having a larger number of mounting points is arranged in one of the component supply units which is on the side where the operator is deployed, the arrangement position determining step being performed by the production equipment arrangement determining apparatus.

According to this configuration, in a component mounting apparatus in which a plurality of mounting heads mount components onto one board in a cooperative manner, after the numbers of tasks of the plurality of mounting heads are equalized, component cassettes for components having a larger number of mounting points can be arranged on the side where the operator is present. In general, components having a larger number of mounting points run out frequently. Thus, when the component cassettes for such components are arranged on the operator side, this arrangement allows the component exchange work to be performed rapidly by the operator, and hence improves the efficiency of the component exchange work performed by the operator.

Furthermore, in the determining step, the arrangement positions of the component cassettes are determined in such a way that the number of component cassettes is relatively greater in one of the component supply units which is on the side where the operator is deployed.

Preferably, the component mounting apparatus is an apparatus which includes a plurality of mounting heads which alternately mount the components onto one board, and each of the plurality of component supply units is provided in the component mounting apparatus to correspond to one of the plurality of mounting heads. The determining step includes: a number-of-pickup-nozzles acquiring step of acquiring the number of pickup nozzles, which pick up the components, provided in each of the plurality of mounting heads, the number-of-pickup-nozzles acquiring step being performed by the production equipment arrangement determining apparatus; an allocation step of allocating the component cassettes for to-be-mounted components to any of the plurality of component supply units in such a way that a ratio of the number of the pickup nozzles is equal to a ratio of the number of mounting points of the components onto the board, the allocation step being performed by the production equipment arrangement determining apparatus; and an arrangement position determining step of determining the arrangement positions of the component cassettes in such a way that the ratio of the number of the pickup nozzles is equal to the ratio of the number of the mounting points of the components onto the board and in such a way that the number of the component cassettes is relatively greater in one of the component supply units which is on the side where the operator is deployed, the arrangement position determining step being performed by the production equipment arrangement determining apparatus.

When arrangement positions for the component cassettes are determined as described here, the operator can perform exchange work for a larger number of kinds of component cassettes at once.

Moreover, the production equipment is a component mounting apparatus which includes component supply units only on one side, and which mounts the components onto the board. In the determining step, a face including the component supply units of the component mounting apparatus is determined as the face where the operator mainly operates the component mounting apparatus.

According to this configuration, in a component mounting apparatus in which component supply units are provided in one face only, the component mounting apparatus can be arranged such that the component supply units are oriented to the operator side. Thus, the operator can perform component exchange work without going to the back side of the component mounting apparatus. This allows the component exchange work to be performed rapidly by the operator, and hence improves the efficiency of the component exchange work performed by the operator.

Preferably, in the determining step, the arrangement of a plurality of production equipment is further determined as a U-shape in which the operator is located in the center, while a face on an inner side of the U-shape is determined as the face where the operator mainly operates each of the production equipment.

Since the production line is formed in the U-shape, when the operator is deployed in the center, moving distances to individual mounting equipment are reduced. Further, when the production line is formed in the U-shape, the faces where the operation units of individual production equipment are present can be oriented to the operator side. Thus, by watching the displays of the operation units of the individual production equipment and by operating the operation units, the operator can simultaneously monitor all the production apparatuses arranged in the U-shape. This reduces the load to the operator in monitoring each production equipment.

Here, in addition to implementation as a method for determining arrangement of production equipment provided with such characteristic steps, the present invention may be implemented as a production equipment arrangement determining apparatus having means made up of the characteristic steps included in the method for determining arrangement of production equipment or alternatively as a program that causes a computer to execute the characteristic steps included in the method for determining arrangement of production equipment. Then, it goes without saying that such program may be distributed via a recording medium such as a Compact Disc-Read Only Memory (CD-ROM) and a communication network such as the Internet.

### EFFECTS OF THE INVENTION

The present invention provides a method for determining arrangement of production equipment that can determine component arrangement positions in a component mounting apparatus such that load to the operator in component exchange and the like is reduced as much as possible.

### BRIEF DESCRIPTION OF DRAWINGS

FIG. 1 is an external appearance view showing a configuration of an electronic component mounting system according to a first embodiment of the present invention.

FIG. 2 is a schematic perspective view of a component mounting system shown in FIG. 1.

FIG. 3 is a flow chart of arrangement processing for production equipment executed by a production equipment arrangement determining apparatus.

FIG. 4 is an external appearance view showing a configuration of a component mounting apparatus according to a second embodiment.

FIG. 5 is a plan view showing a main configuration of the inside of a component mounting apparatus according to the second embodiment.

FIG. 6 is a schematic diagram showing positional relation between a line gang pickup head and a component cassette.

FIG. 7 is a diagram describing component mounting performed by a component mounting apparatus according to the second embodiment.

FIG. 8 is a diagram describing component mounting performed by a component mounting apparatus according to the second embodiment.

FIG. 9 is a block diagram showing an exemplary configuration of a production equipment arrangement determining apparatus.

FIG. 10 is a diagram showing an example of mounting point data.

FIG. 11 is a diagram showing an example of a component library.

FIG. 12 is a diagram showing an example of mounting apparatus information.

FIG. 13 is a diagram showing an example of number-of-mounting-points information.

FIG. 14 is a flow chart showing determination processing for a component mounting order and component arrangement determination processing for component supply units executed by a production equipment arrangement determining apparatus.

FIG. 15 is a diagram describing arrangement position determination processing for components.

FIG. 16 is a diagram showing an example of number-of-mounting-points information.

FIG. 17 is a diagram describing arrangement position determination processing for components.

FIG. 18 is a diagram describing the relation of distance between the center position of a board and the normal stop position of a line gang pickup head in a case where a small board is transferred.

FIG. 19 is a diagram describing the relation of distance between the center position of a board and the normal stop position of a line gang pickup head in a case where a large board is transferred.

FIG. 20 is an external appearance view of a component mounting apparatus according to a third embodiment, viewed aslant from the front.

FIG. 21 is a plan view showing an internal main configuration of a component mounting apparatus according to the third embodiment.

FIG. 22 is a flow chart showing determination processing for a component mounting order and component arrangement determination processing for a component supply unit which is executed for a component mounting apparatus according to the third embodiment by a production equipment arrangement determining apparatus.

FIG. 23 is a diagram describing a change in number-of-mounting-points information.

FIG. 24 is a diagram describing arrangement position determination processing for components.

FIG. 25 is a schematic perspective view of an electronic component mounting system according to a fourth embodiment of the present invention.

FIG. 26 is an external appearance view of a component mounting apparatus according to the fourth embodiment, viewed aslant from the front.

FIG. 27 is a schematic diagram showing positional relation between a component supply unit and a rotary head.

FIG. 28 is a diagram schematically showing positional relation among a rotary head, a board and a component supply unit.

FIG. 29 is a diagram describing arrangement position determination processing for components.

### NUMERICAL REFERENCES

10, 30 Electronic component mounting system
20, 20a, 20b Board
100, 192 Stocker
112, 158 Solder printing apparatus
113, 117, 127a, 127b, 141a, 141b, 153, 159, 516 Operation unit
114 and 154, 150, 160, 182 Conveyor
116, 162 Adhesive application apparatus
120, 140, 170, 180, 400, 500 Component mounting apparatus
163, 171a, 181a, 401a, 401b Operation unit
120a Front sub-equipment
120b Rear sub-equipment
120c Left sub-equipment
120d Right sub-equipment
121, 510 Line gang pickup head
121a, 121b Pickup nozzle
122 Beam
123 Component cassette
124a, 124b, 402, 515, 515a, 515b, 515c, 515d Component supply unit
126 Component recognizing camera
128 Tray supply unit
129, 521 Rail
129a Fixed rail
129b Moving rail
130a, 130b, 132a, 132b Sub-equipment
152, 190 Reflow furnace
156 Board reversing apparatus
191 Operation unit
200 Operator
300 production equipment arrangement determining apparatus
301 Arithmetic control unit
302 Display unit
303 Input unit
304 Memory unit
305 Determination program storing unit
305a Mounting order determining unit
305b Component arrangement determining unit
306 Communication I/F unit
307 Database unit
307a Mounting point data
307b Component library
307c Mounting apparatus information
307d Number-of-mounting-points information
403 Rotary head
404 XY table
405 Rotary base
406 Sequential mounting head
406 Mounting head
409 Suction opening
513 XY robot
519 Nozzle station
523 Component collecting apparatus

### BEST MODE FOR CARRYING OUT THE INVENTION

An electronic component mounting system according to embodiments of the present invention is described below with reference to the drawings.

### First Embodiment

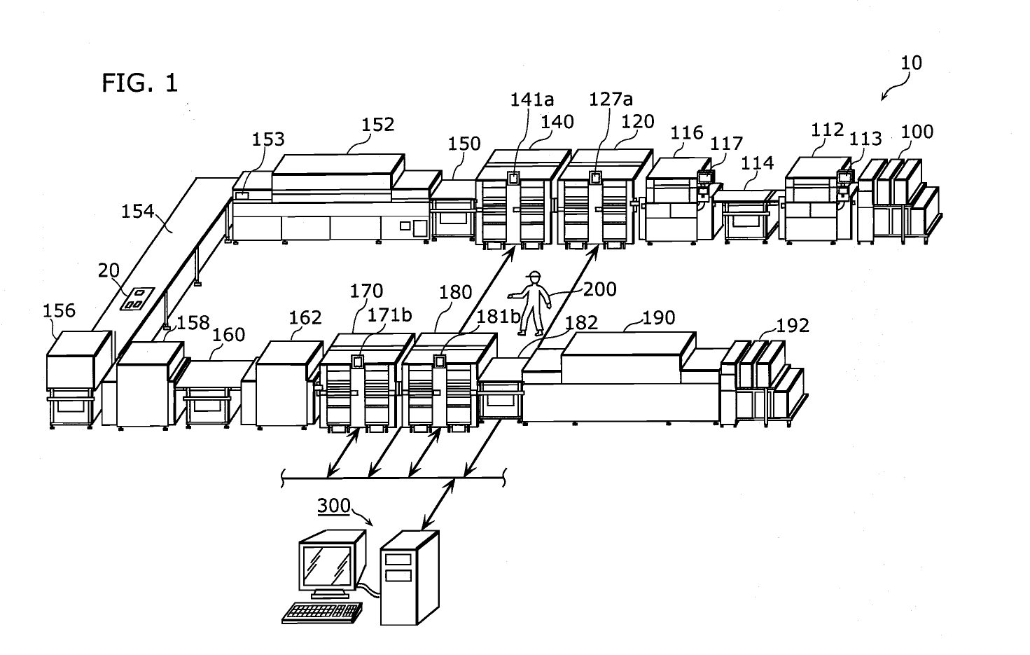

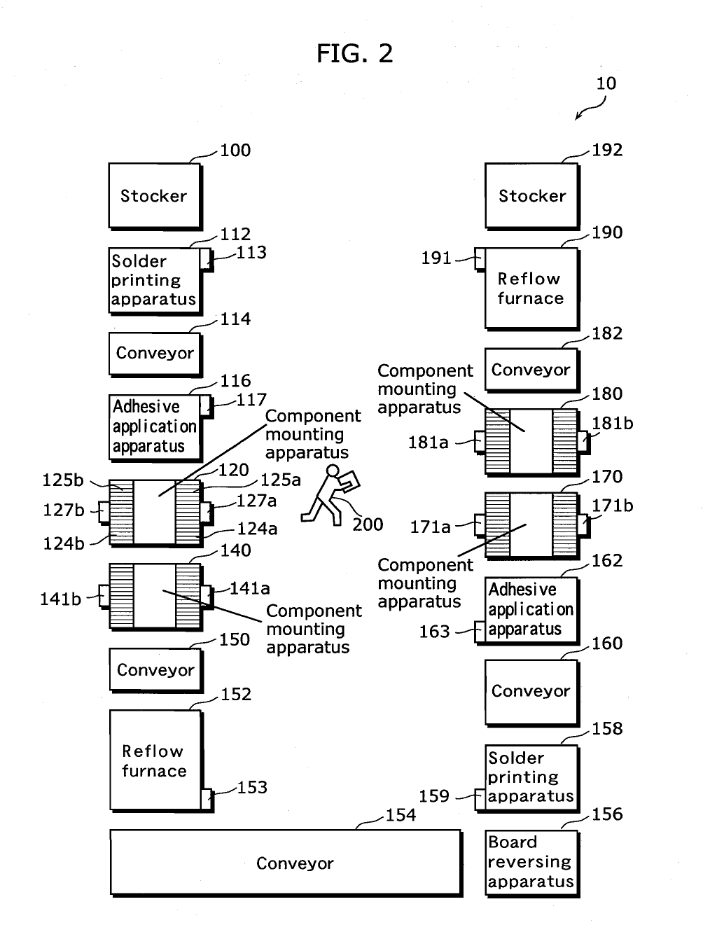

FIG. 1 is an external appearance view showing a configuration of an electronic component mounting system. FIG. 2 is a schematic diagram of the component mounting system shown in FIG. 1, viewed from the above.

The electronic component mounting system 10 is a system in which a board is transferred from production equipment located in the upstream to production equipment located in the downstream so that an electronic component mounting board is produced in which electronic components are mounted on both surfaces of the board. The electronic component mounting system 10 includes, from the upstream, a stocker 100, a solder printing apparatus 112, a conveyor 114, an adhesive application apparatus 116, a component mounting apparatus 120, a component mounting apparatus 140, a conveyor 150, a reflow furnace 152, a conveyor 154, a board reversing apparatus 156, a solder printing apparatus 158, a conveyor 160, an adhesive application apparatus 162, a component mounting apparatus 170, a component mounting apparatus 180, a conveyor 182, a reflow furnace 190 and a stocker 192.

The stockers 100 and 192 are apparatuses that stock boards. The stocker 100 is located in the uppermost stream of the production line, while the stocker 192 is located in the lowermost stream of the production line. That is, the stocker 100 stocks boards on which components are not yet mounted, while the stocker 192 stocks finished boards on which components are already mounted.

The solder printing apparatuses 112 and 158 are apparatuses that print solder on the surface of a board. In the front faces of the solder printing apparatuses 112 and 158, operation units 113 and 159 are provided respectively for operating the solder printing apparatuses.

The conveyors 114, 150, 154, 160 and 182 are apparatuses that transfer a board. The adhesive application apparatuses 116 and 162 are apparatuses that apply adhesive on a board.

The reflow furnaces 152 and 190 are apparatuses that heat up a board 20 on which components are mounted and thereby melts the solder or the like so as to fix the components onto the board. In the front faces of the reflow furnaces 152 and 190, operation units 153 and 191 are provided respectively for operating the reflow furnaces.

In the configuration of the electronic component mounting system 10, as shown in the figure, the production equipment is arranged in the shape of a “U”. An operator 200 is deployed in the center (on the inner side of U) of the electronic component mounting system 10. In the following description, the inner side of U, that is, the side where the operator 200 is deployed, is referred to as the “inner side of the electronic component mounting system 10”. Further, the outer side of U is referred to as the “outer side of the electronic component mounting system 10”.

When the production equipment is arranged in the shape of a U, the operation units of individual production equipment are necessarily oriented to the inner side of the electronic component mounting system 10. That is, the operation unit 113 for operating the solder printing apparatus 112, the operation unit 117 for operating the adhesive application apparatus 116, the operation unit 127a for operating the component mounting apparatus 120, the operation unit 141a for operating the component mounting apparatus 140 and the operation unit 153 for operating the reflow furnace 152 are oriented to the inner side of the electronic component mounting system 10. Further, the operation unit 159 for operating the solder printing apparatus 158, the operation unit 163 for operating the adhesive application apparatus 162, the operation unit 171a for operating the component mounting apparatus 170, the operation unit 181a for operating the component mounting apparatus 180 and the operation unit 191 for operating the reflow furnace 190 are oriented to the inner side of the electronic component mounting system 10. Thus, the operator can operate individual production equipment without moving to the outer side of the electronic component mounting system 10. Here, in to each of the component mounting apparatuses 120, 140, 170 and 180, an operation unit is provided in each of the front and rear faces of each apparatus. This is because components can be supplied from both surfaces of the component mounting apparatus. That is, when the operator 200 is to supply components to the component mounting apparatus, in order that a position where the components are to be supplied should be notified, an operation unit is provided in each face. Accordingly, when watching the display contained in the operation unit, the operator 200 easily understands the position where the components are to be supplied.

Such U-shape arrangement is an example of arrangement of the production equipment determined by the determination of the face where the operator mainly operates the production equipment. Here, in addition to the above-mentioned face containing the operation unit, the “face where the operator mainly operates the production equipment” may be, for example, a face containing a component supply unit for operation of component cassette exchange, maintenance and the like. The word “mainly” mentioned here indicates a higher frequency of the operation.

As for a board 20 accommodated in the stocker 100, after electronic components are mounted onto the front surface of the board 20 by the production equipment ranging from the solder printing apparatus 112 to the reflow furnace 152, the board 20 is transferred to the board reversing apparatus 156 by the conveyor 154. The board reversing apparatus 156 reverses the surface of the board 20. Then, after electronic components are mounted onto the back surface of the board 20 by the production equipment ranging from the solder printing apparatus 158 to the reflow furnace 190, the electronic component mounting board is accommodated into the stocker 192.

Here, the component mounting apparatuses 120, 140, 170 and 180 are connected to the production equipment arrangement determining apparatus 300.

The production equipment arrangement determining apparatus 300 is a computer that performs the processing of determining the face where the operator mainly operates the production equipment. More specifically, in addition to arrangement of the production equipment, the computer determines arrangement of the component cassettes, a mounting order for the components and the like. That is, as described in an embodiment given later, the production equipment arrangement determining apparatus 300 performs the processing of determination of a mounting order for the components onto the board 20, determination of supplying positions for the components to each component mounting apparatus and the like. Here, in place of “determination of a mounting order” and “determination of supplying positions for the components”, the production equipment arrangement determining apparatus 300 may perform “optimization of the mounting order” and “optimization of supplying positions for the components”. Alternatively, the production equipment arrangement determining apparatus 300 may perform determination or optimization of the mounting order or the arrangement positions for the components such that the mounting time for the components is reduced. Further, the function of the production equipment arrangement determining apparatus 300 may be provided in individual production equipment (e.g., component mounting apparatuses).

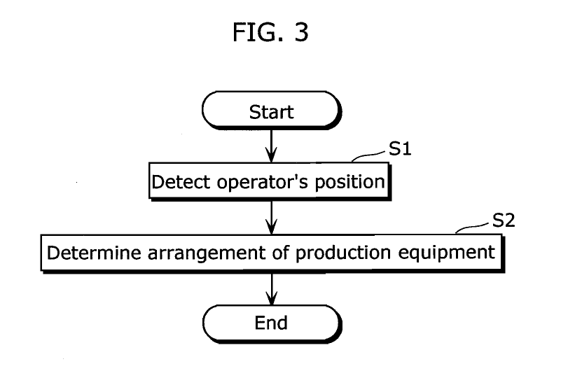

Here, arrangement processing for production equipment performed by the production equipment arrangement determining apparatus 300 is described below. FIG. 3 is a flow chart of arrangement processing for production equipment executed by the production equipment arrangement determining apparatus 300. The production equipment arrangement determining apparatus 300 detects the operator position relative to the production equipment (S1). Then, based on the operator position relative to the production equipment, the production equipment arrangement determining apparatus 300 determines a face where the operator mainly operates it, and then determines arrangement of the production equipment (S2).

First, the operator position detection processing (S1) is described. For example, the operator may input the side where the operator is located relative to the production equipment, through the operation unit provided in each production equipment. Then, the information may be transmitted to the production equipment arrangement determining apparatus 300. Alternatively, the side where the operator is located relative to the production equipment may be inputted through a portable terminal owned by the operator. Then, the information may be transmitted to the production equipment arrangement determining apparatus 300. Further, the position of a portable terminal may automatically be acquired using the Global Positioning System (GPS) or the like, so that the side where the operator is located relative to the production equipment may be detected. Then, the detection result may be transmitted to the production equipment arrangement determining apparatus 300. Further, the production equipment arrangement determining apparatus 300 may count and compare the number of times of input from the operator through the operation unit provided in the front face of the production equipment and the number of times of input from the operator through the operation unit provided in the rear face. Then, it may be determined that the operator is present on the side having the greater number of times of operation. Furthermore, when the production equipment is a component mounting apparatus, the number of times of exchange of component cassettes in the front component supply unit and the number of times of exchange of component cassettes in the rear component supply unit may be counted and compared. Then, it may be determined that the operator is present on the side having the greater number of times of exchange of component cassettes.

Next, the production equipment arrangement determination processing (S2) is described. For example, in the case of a production equipment in which an operation unit is provided on one side only, in order that an arrangement should be adopted that the face containing the operation unit is oriented to the side where the operator is located, the production equipment arrangement determining apparatus 300 may perform announcement or alternatively may perform display on the screen of the production equipment arrangement determining apparatus 300. Further, in the case where the production equipment is a component mounting apparatus in which a component supply unit is provided in the front face and the rear face, arrangement of the component cassettes may be determined such that exchange of the component cassettes occurs more frequently in the component supply unit on the side where the operator is present. Such arrangement determination processing for component cassettes is described later in second and third embodiments. Further, in the case where the production equipment is a component mounting apparatus in which a component supply unit is provided on one side only, in order that an arrangement should be adopted that the face containing the component supply unit is oriented to the side where the operator is located, the production equipment arrangement determining apparatus 300 may perform announcement or alternatively may perform display on the screen of the production equipment arrangement determining apparatus 300. Details of such arrangement processing of a component mounting apparatus are described later in a fourth embodiment.

Here, in production equipment (e.g., a component mounter) in which an operation unit is provided on both the inner side and the outer side of the electronic component mounting system 10, arrangement of the production equipment may be adopted such that the side where an operation unit mainly operated by the operator is present is oriented to the side where the operator is located, that is, the inner side of the electronic component mounting system 10.

As described above, according to this embodiment, the production line is formed in the U-shape. Thus, when the operator is deployed in the center, moving distances to individual mounting equipment are reduced. Further, when the production line is formed in the U-shape, the front face of the production equipment in the production line that mounts components onto the front surface of a board and the front face of the production equipment in the production line that mounts components onto the back surface of the board are oriented to the inner side of the electronic component mounting system. Thus, by watching the displays of the operation units of the individual production equipment and by operating the operation units, the operator can simultaneously monitor the two lines. This reduces the load to the operator in monitoring each production equipment.

### Second Embodiment

Next, a component mounting system according to a second embodiment of the present invention is described below. The electronic component mounting system according to the second embodiment has a configuration similar to that of the electronic component mounting system 10 shown in FIGS. 1 and 2. However, the configuration of the component mounting apparatuses 120, 140, 170 and 180 is as described below.

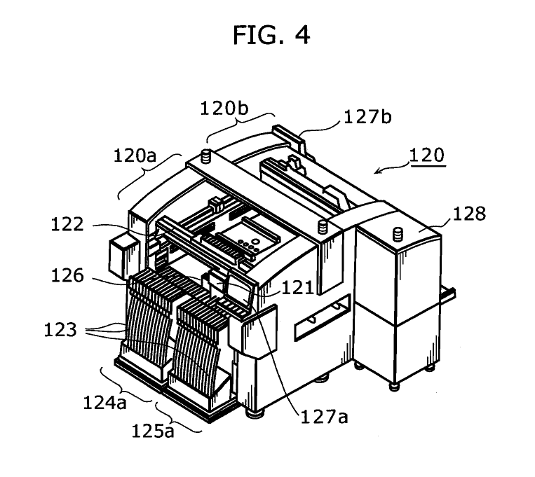

FIG. 4 is an external appearance view showing a configuration of the component mounting apparatus 120.

The component mounting apparatus 120 includes two sub-equipment (front sub-equipment 120a and rear sub-equipment 120b) that perform component mounting in a cooperated manner (or alternatively in alternate operation). The front sub-equipment 120a includes: two component supply units 124a and 125a composed of an array of component cassettes 123 each accommodating a component tape; a line gang pickup head 121 having a plurality of pickup nozzles (referred to simply as “nozzles”, in some cases hereinafter) capable of picking up electronic components from the component cassettes 123 and mounting them onto a board 20; a beam 122 to which the line gang pickup head 121 is attached; and a component recognizing camera 126 that inspects in a two-dimensional or three-dimensional manner the pickup state of components picked up by the line gang pickup head 121. The rear sub-equipment 120b also has a configuration similar to that of the front sub-equipment 120a. Here, the rear sub-equipment 120b has a tray supply unit 128 for supplying tray components. However, the tray supply unit 128 and the like are not provided in some cases depending on the sub-equipment.

Here, the “component tape” indicates a tape (carrier tape) on which a plurality of components of the same component type are arranged. This tape is supplied in a state wound around a reel (supply reel) or the like, and is used mainly for supplying components having a comparatively small size and referred to as chip components, to a component mounting apparatus.

Specifically, the component mounting apparatus 120 is a mounting apparatus that has both the function of a component mounting apparatus referred to as a high-speed mounter and the function of a component mounting apparatus referred to as a multifunctional mounter. The high-speed mounter generally indicates an apparatus that mounts electronic components of 10 mm square or smaller at a speed of 0.1 second each or the like and that is characterized by high productivity. The multifunctional mounter indicates an apparatus that mounts large-size electronic components of 10 mm square or larger, irregularly shaped components such as switches and connectors, and IC components such as a Quad Flat Package (QFP) and a Ball Grid Array (BGA).

That is, the component mounting apparatus 120 is designed to be capable of mounting almost all types of electronic components (the range of components to be mounted extends from a 0.4 mm×0.2 mm chip resistor to a 200 mm connector). Thus, when a necessary number of component mounting apparatuses 120 are merely arranged, a mounting line can be constructed.

Here, the configuration of the component mounting apparatuses 140, 170 and 180 is similar to that of the component mounting apparatus 120. Thus, detailed description is not repeated here.

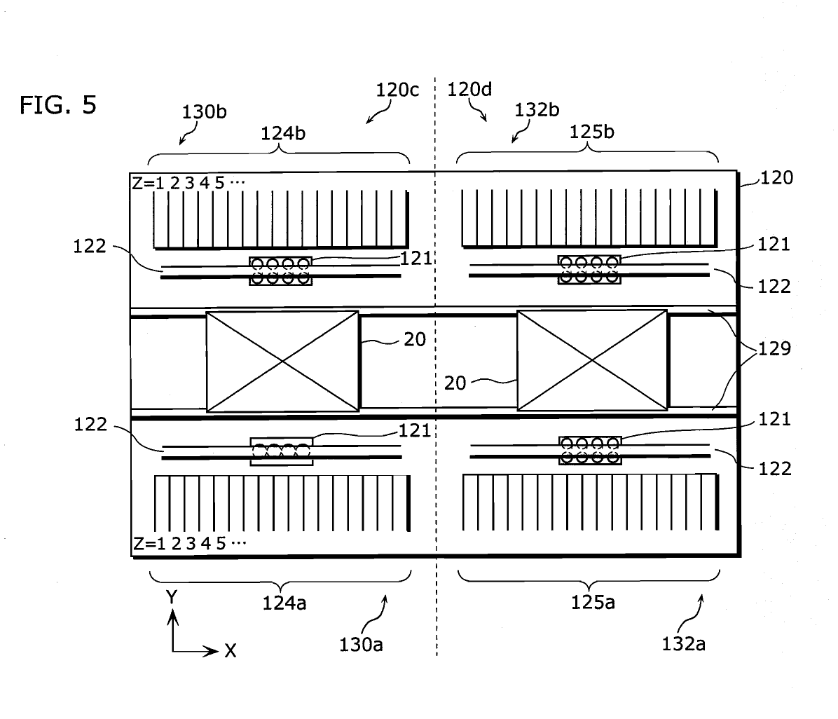

FIG. 5 is a plan view showing a major configuration of the inside of the component mounting apparatus 120.

The component mounting apparatus 120 includes in the inside: sub-equipment arranged in the transportation direction for the board 20 (X-axis direction); and sub-equipment arranged in the forward and backward directions (Y-axis direction) of the component mounting apparatus 120. In total, the component mounting apparatus 120 includes four sub-equipment 130a, 132a, 130b and 132b. Here, the component mounting apparatus 120 shown in FIG. 4 includes two sub-equipment. However, in the component mounting apparatus 120 shown in FIG. 5, for simplicity of description, an internal configuration is shown in the case where two component mounting apparatuses 120 shown in FIG. 4 are linked in the transportation direction for the board 20. Thus, the following description is given.

The sub-equipment (130a/132a and 130b/132b) arranged in the X-axis direction are mutually independent, and hence can simultaneously perform mutually different mounting work. Further, the sub-equipment (130a/132b and 132b/130b) are also mutually independent, and hence can simultaneously perform mutually different mounting work. On the other hand, the sub-equipment (130a/130b and 132a/132b) facing with each other in the forward and backward directions (Y-axis direction) cooperate with each other so as to perform mounting work on one board. In the following description, the sub-equipment 130a and 130b are collectively referred to as “left sub-equipment 120c”, while the sub-equipment 132a and 132b are collectively referred to as “right sub-equipment 120d”. That is, in each sub-equipment of the left sub-equipment 120c and the right sub-equipment 120d, two line gang pickup heads 121 perform component mounting work onto one board 20 in a cooperated manner.

In the sub-equipment 130a, 132a, 130b and 132b, each sub-equipment 130a, 132a, 130b and 132b is provided with a beam 122, a line gang pickup head 121 and a component supply units 124a, 125a, 124b and 125b. Further, in the component mounting apparatus 120, a pair of rails 129 for board 20 transportation are provided between the front and rear sub-equipment.

The rails 129 are composed of a fixed rail 129a and a moving rail 129b. The position of the fixed rail 129a is fixed in advance, whereas the moving rail 129b can be moved in the Y-axis direction in accordance with the length of the transported board 20 in the Y-axis direction.

Here, the component recognizing camera 126, the tray supply unit 128 and the like are not essential parts of the present invention. Thus, description is omitted in the figure.

The beam 122 is a rigid body extending in the X-axis direction, and can move on a railway (not shown) provided in the Y-axis direction (perpendicular to the transportation direction for the board 20), with maintaining the state of being parallel to the X-axis direction. Further, the beam 122 allows the line gang pickup head 121 attached to the beam 122 to move along the beam 122, that is, in the X-axis direction. Thus, by virtue of the movement of itself in the Y-axis direction and the X-axis directional movement of the line gang pickup head 121 that moves in the Y-axis direction in association with the above-mentioned movement, the line gang pickup head 121 can move freely in the XY plane. Further, a plurality of motors such as motors (not shown) for driving these are provided in the beam 122. Electric power to these motors and the like is supplied via the beam 122.

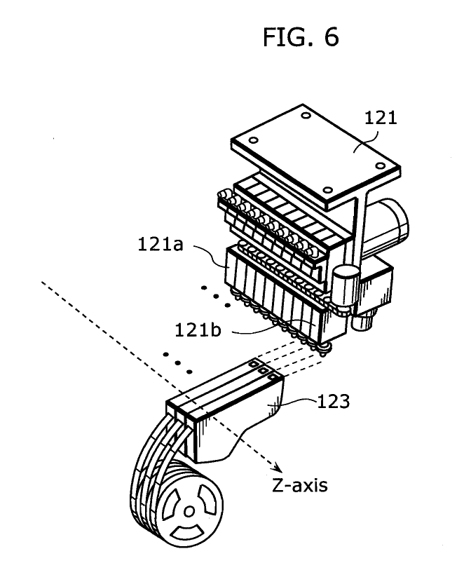

FIG. 6 is a schematic diagram showing positional relation between a line gang pickup head 121 and a component cassette 123.

The line gang pickup head 121 can be equipped with a plurality of pickup nozzles 121a to 121b, and can pick up electronic components of a number equal to the number of pickup nozzles at maximum in an ideal case, from the individual component cassettes 123 simultaneously (by in one iteration of a lowering and raising operation).

The line gang pickup head 121 can move along the beam 122. This movement is driven by a motor (not shown). Further, the lowering and raising operation at the time of picking up and holding the electronic components and mounting the held electronic components onto the board 20 is also driven by a motor.

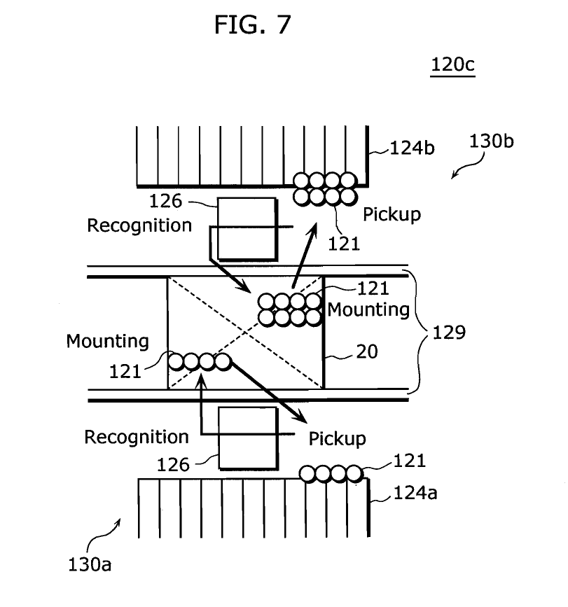

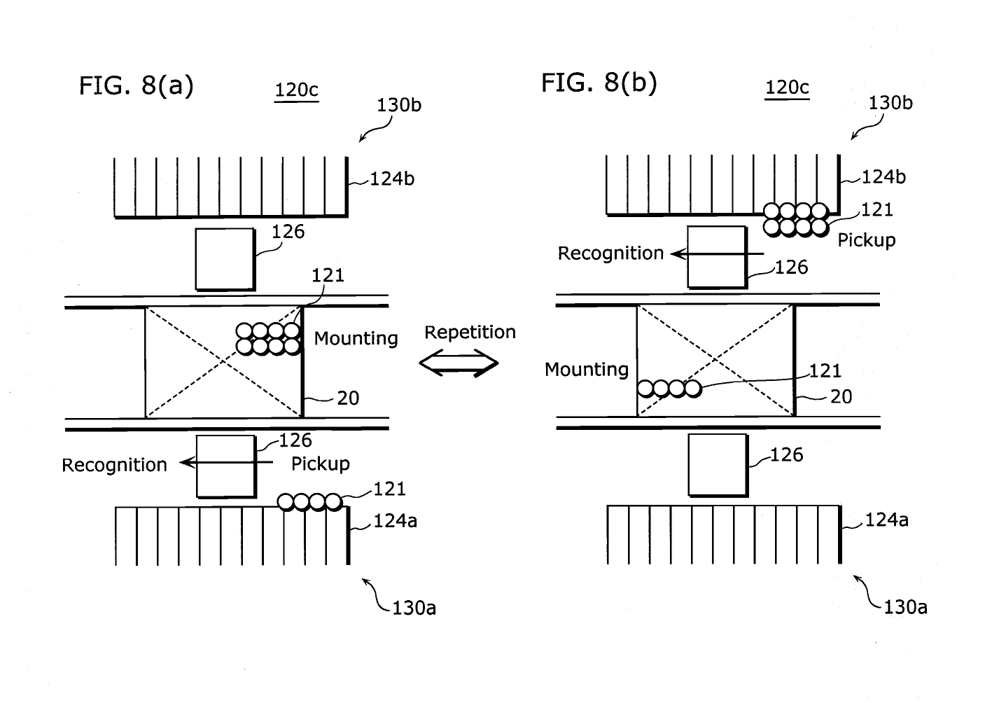

FIGS. 7 and 8 are diagrams describing component mounting performed by a component mounting apparatus 120. Here, in FIGS. 7 and 8, only the left sub-equipment 120c is illustrated. However, the right sub-equipment 120d operates similarly so as to mount components. Thus, the right sub-equipment is omitted in FIGS. 7 and 8.

As shown in FIG. 7, the line gang pickup head 121 of the sub-equipment 130b alternately repeats three kinds of operation composed of “pickup” of the components from the component supply unit 124b, “recognition” of the picked-up components by using the component recognizing camera 126, and “mounting” of the recognized components onto the board 20, and thereby mounts the components onto the board 20.

Here, the line gang pickup head 121 of the sub-equipment 130a similarly repeats alternately the three kinds of operation composed of “pickup”, “recognition” and “mounting”, and thereby mounts the components onto the board 20.

Here, when the two line gang pickup heads 121 simultaneously perform “mounting” of the components, in order that collision should be avoided between the line gang pickup heads 121, the two line gang pickup heads 121 mounts the components onto the board 20 in the form of coordinated operation. Specifically, as shown in FIG. 8(a), when the line gang pickup head 121 of the sub-equipment 130b performs “mounting” operation, the line gang pickup head 121 of the sub-equipment 130a performs “pickup” operation and “recognition” operation. In contrast, as shown in FIG. 8(b), when the line gang pickup head 121 of the sub-equipment 130a performs “mounting” operation, the line gang pickup head 121 of the sub-equipment 130b performs “pickup” operation and “recognition” operation. As such, when the two line gang pickup heads 121 perform “mounting” operation alternately, collision can be avoided between the line gang pickup heads 121. Here, in an ideal case, during the time that “mounting” operation is performed by one line gang pickup head 121, if “pickup” operation and “recognition” operation by the other line gang pickup head 121 are completed, the “mounting” operation to be performed by the other line gang pickup head 121 can be started without delay at the time that the “mounting” operation by one of the line gang pickup heads 121 has been completed. This improves production efficiency.

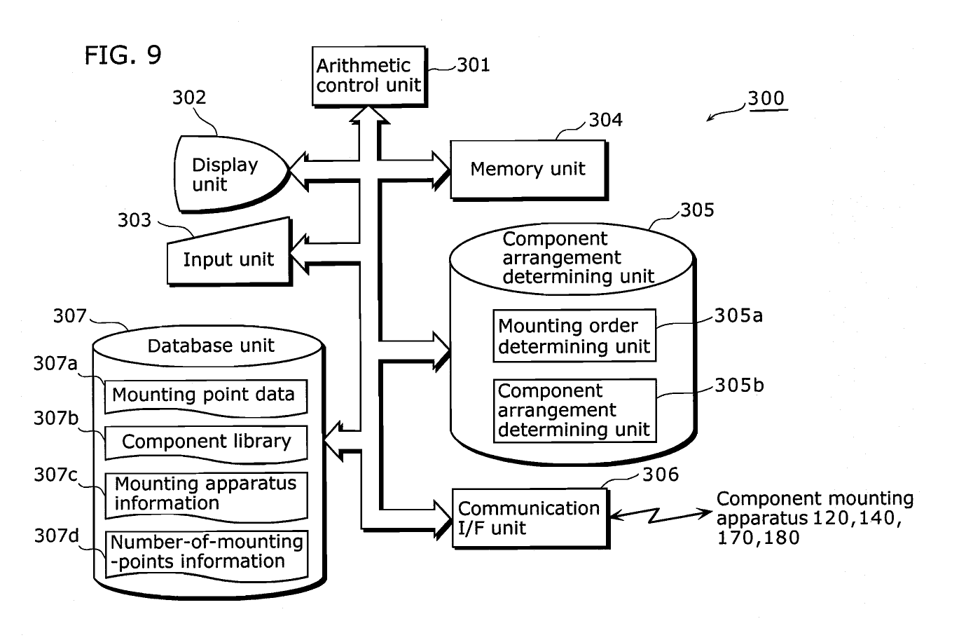

FIG. 9 is a block diagram showing an exemplary configuration of a production equipment arrangement determining apparatus 300 according to an embodiment of the present invention, that is, the production equipment arrangement determining apparatus 300 shown in FIG. 1. The production equipment arrangement determining apparatus 300 is a computer for performing the processing of determining a component mounting order onto the board 20 for each component mounting apparatus and determining component supplying positions for each component mounting apparatus, and includes an arithmetic control unit 301, a display unit 302, an input unit 303, a memory unit 304, a program storing unit 305, a communication I/F (interface) unit 306, and a database unit 307. As described below, the production equipment arrangement determining apparatus 300 determines arrangement of component cassettes such that the number of times of operation (the number of times of exchange of component cassettes) by the operator should be greater in the component supply unit located in the face where the operator is deployed.

The production equipment arrangement determining apparatus 300 is implemented by a general-purpose computer system such as a personal computer that executes a determination program according to the present invention. In a state not connected to the component mounting apparatus 120, the production equipment arrangement determining apparatus 300 serves also as a stand-alone simulator (a tool for component mounting order determination). Here, the production equipment arrangement determining apparatus may be installed inside the component mounting apparatus.

The arithmetic control unit 301 is a Central Processing Unit (CPU), a numerical processor, or the like. In accordance with an instruction from the operator or the like, the arithmetic control unit 301 loads a necessary program from the determination program storing unit 305 to the memory unit 304 and executes it so as to control the individual units 302 to 307 in accordance with the execution result.

The display unit 302 is a Cathode-Ray Tube (CRT), a Liquid Crystal Display (LCD) or the like, while the input unit 303 is a keyboard, a mouse and the like. These units are used for interactive operation or the like between the production equipment arrangement determining apparatus 300 and an operator, under the control of the arithmetic control unit 301.

The communication I/F unit 306 is a Local Area Network (LAN) adapter or the like, and is used for communication and the like between the production equipment arrangement determining apparatus 300 and the component mounting apparatus 120. The memory unit 304 is a Random Access Memory (RAM) or the like that provides a working area for the arithmetic control unit 301.

The database unit 307 is a hard disk or the like that stores, for example: input data (such as the mounting point data 307a, the component library 307b, the mounting apparatus information 307c and the number-of-mounting-points information 307d) used for the above-mentioned determination processing performed by the production equipment arrangement determining apparatus 300; and mounting point data and component arrangement data generated by the determination processing.

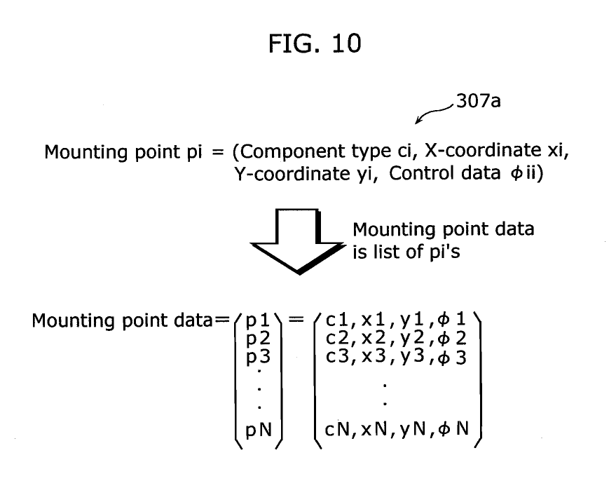

FIGS. 10 to 13 are diagrams respectively showing examples of the mounting point data 307a, the component library 307b, the mounting apparatus information 307c and the number-of-mounting-points information 307d.

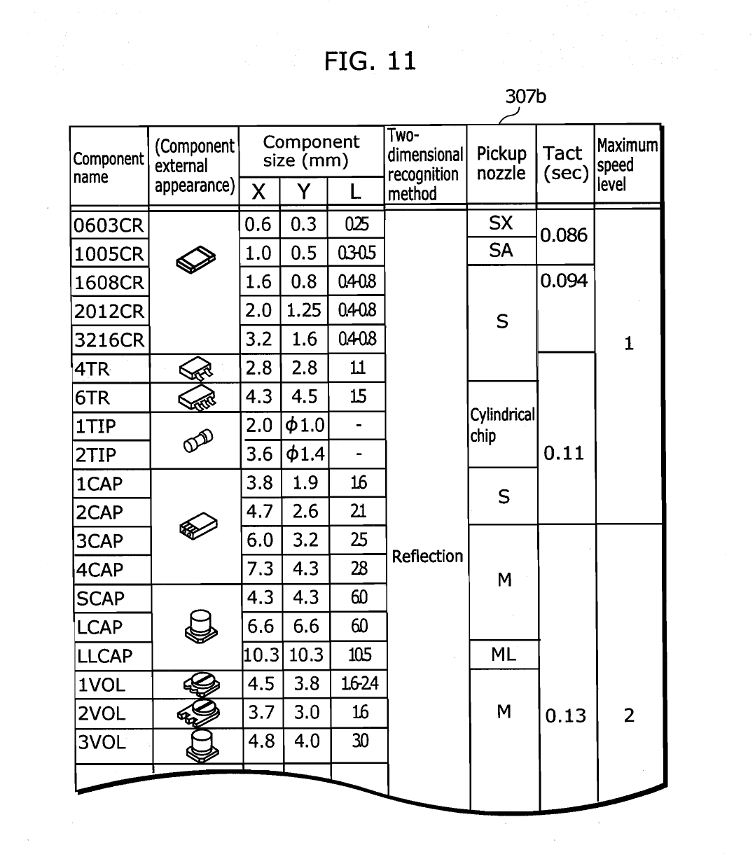

The mounting point data 307a is a group of information that indicates the mounting points for all components to be mounted. As shown in FIG. 10, one mounting point pi includes a component type ci, an X-coordinate xi, a Y-coordinate yi and control data θi. Here, the “component type” corresponds to the component name in the component library 307b shown in FIG. 11. The “X-coordinate” and the “Y-coordinate” are the coordinates of the mounting point (coordinates that indicate a particular position on the board). The “control data” is restriction information concerning the mounting of the component (such as the type of a pickup nozzle that can be used and the highest transportation speed of the line gang pickup head 121). Here, Numeric Control (NC) data to be acquired finally is a sequence of mounting points that minimizes a line tact.

The component library 307b is a library generated by collecting information specific to each of all component types that can be processed by the component mounting apparatus 120. As shown in FIG. 11, the component library 307b contains for each component type: a component size; a tact (the tact specific to the component type under a particular condition); and other restriction information (such as the type of a pickup nozzle that can be used, the recognition method used by the component recognition camera 126, and the maximum speed ratio of the line gang pickup head 121). Here, in the figure, external appearances of components of various component types are also shown for convenience.

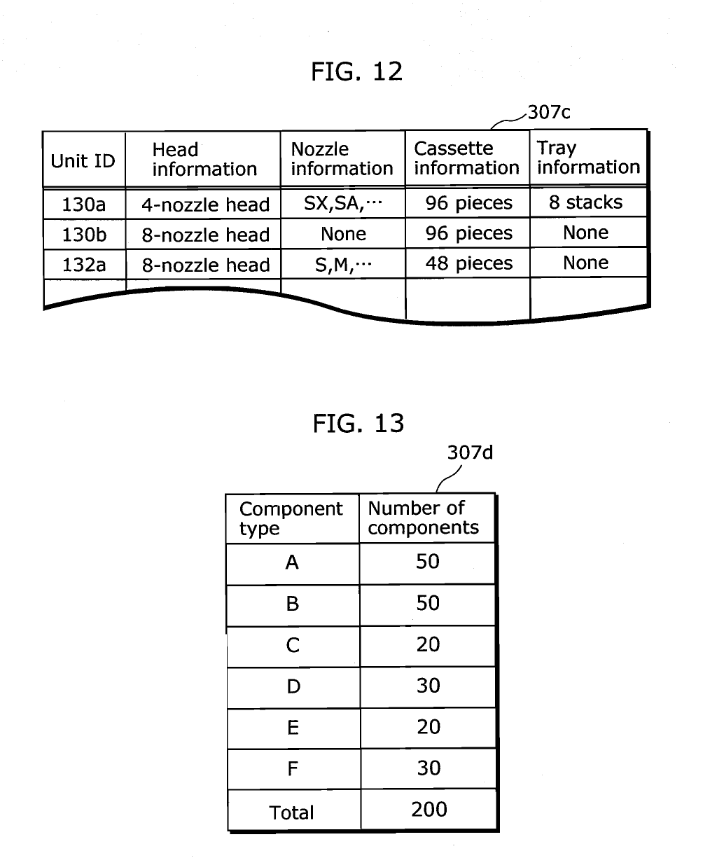

The mounting apparatus information 307c is information that indicates the apparatuses configuration, the above-mentioned restriction, and the like for all individual sub-equipment that make up the production line. As shown in FIG. 12, the mounting apparatus information 307c includes: head information concerning the type of the line gang pickup head 121, that is, for example, concerning the number of pickup nozzles provided in the line gang pickup head 121; nozzle information, for example, concerning the type of the pickup nozzles that can be attached to the line gang pickup head 121; cassette information, for example, concerning the maximum number of component cassettes 123; and tray information, for example, concerning the number of trays held in the tray supply unit 128.

The number-of-mounting-points information 307d is provided for each of the left sub-equipment 120c and the right sub-equipment 120d. As shown in FIG. 13, the number-of-mounting-points information 307d is information in which correspondence is established between each component type of the mounting point to be mounted onto the board 20 and its number (the number of mounting points for the component). For example, in FIG. 13, when the number-of-mounting-points information 307d concerning the left sub-equipment 120c is shown, component types to be mounted by the left sub-equipment 120c are six consisting of A, B, C, D, E and F, while the numbers of mounting points for these are 50, 50, 20, 30, 20 and 30.

The determination program storing unit 305 shown in FIG. 9 is a hard disk or the like that stores various determination programs for implementing the function of the production equipment arrangement determining apparatus 300. The determination programs are programs that determine a mounting order for the components and supplying positions for the components in the component mounting apparatus. In terms of function (in the form of processing units that express the function when executed by the arithmetic control unit 301), the program includes a mounting order determining unit 305a, a component arrangement determining unit 305b and the like.

Based on various kinds of data stored in the database unit 307, the mounting order determining unit 305a acquires mounting order for the components so that the mounting time for the components onto the board 20 is minimized.

The component arrangement determining unit 305b determines arrangement positions for the component cassettes 123 in the component supply units 124a, 125a, 124b and 125b. The processing executed by the component arrangement determining unit 305b is described later.

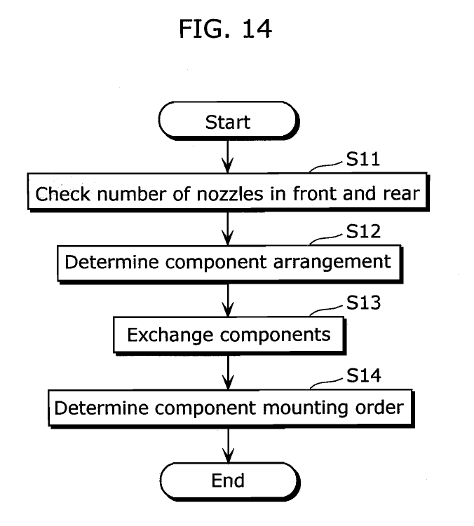

Next, the operation of the production equipment arrangement determining apparatus 300 having the above-mentioned configuration is described below. FIG. 14 is a flow chart showing determination processing for a component mounting order and component arrangement determination processing for the component supply units executed by the production equipment arrangement determining apparatus 300.

In the following description, the determination processing in the left sub-equipment 120c is described. However, similar determination processing is performed also in the right sub-equipment 120d. Further, similar determination processing is performed also in the other component mounting apparatuses. First, the component arrangement determining unit 305b checks the number of pickup nozzles 121a of the line gang pickup head 121 provided in each of the sub-equipment 130a and the sub-equipment 130b (S11). Then, based on the ratio of the numbers of pickup nozzles 121a of the two line gang pickup heads 121 checked in the processing S11, the component arrangement determining unit 305b assigns the component cassettes for the component types described in the number-of-mounting-points information 307d to the components supply units 124a and 124b (S12). As such, when the components are assigned to the two component supply units based on the ratio of the numbers of pickup nozzles 121a, the number of tasks can be made equal in the sub-equipment 130a and in the sub-equipment 130b at the time that the two line gang pickup heads 121 perform coordinated operation so as to mount components onto one board 20. Here, the “task” indicates one iteration of series operation among a repeated series of operations composed of pickup, transportation and mounting of the components performed by the line gang pickup head 121.

For example, the numbers of pickup nozzles 121a of the line gang pickup heads 121 of the sub-equipment 130a and 130b are assumed to be 4 and 8, respectively. Further, the total of the number described in the number-of-mounting-points information 307d is assumed to be 120. In this case, the component types are assigned to the component supply units 124a and 124b such that the total of the number of component types is divided into 4:8. That is, 40 components are assigned to the component supply unit 124a, while 80 components are assigned to the component supply unit 124b. Thus, the number of tasks of the sub-equipment 130a becomes 40/4=10 tasks, while the number of tasks of the sub-equipment 130b becomes 80/8=10 tasks. As a result, the numbers of tasks are equal to each other.

Then, the component arrangement determining unit 305b exchanges between the component supply unit 124a and the component supply unit 124b the arrangement positions for the components assigned in the processing S12, into a state that components having a larger number of mounting points (the numbers of components) are arranged on the inner side of the electronic component mounting system 10, that is, in the component supply unit 124a (S13).

Finally, based on the arrangement positions for the components determined by the component arrangement determining unit 305b, the mounting order determining unit 305a determines a mounting order for the components (S14). Here, as for the determining method for a mounting order for the components, various methods have been proposed in the conventional art. Thus, detailed description is not repeated here.

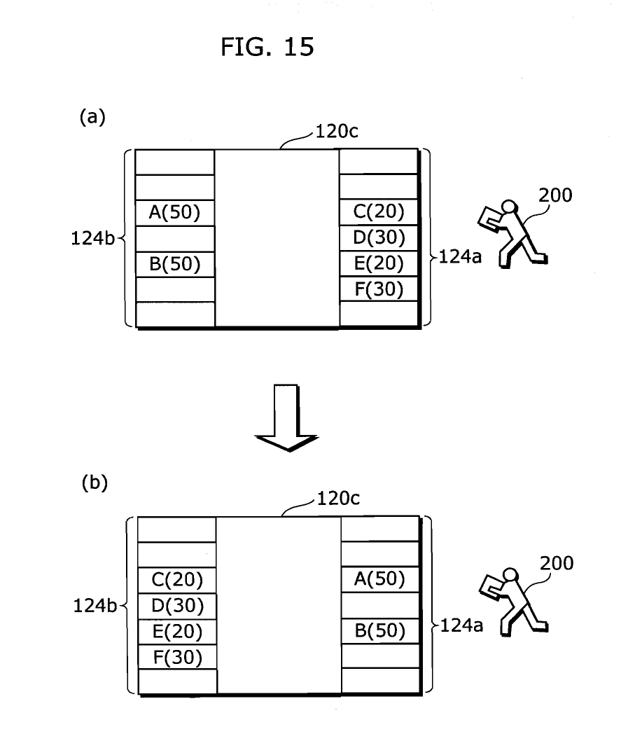

Next, with reference to a detailed example, the arrangement position determination processing (S11 to S13 in FIG. 14) for the components performed by the component arrangement determining unit 305b is described in further detail. FIG. 15 is a diagram describing arrangement position determination processing for components. In this example, the numbers of pickup nozzles 121a of the line gang pickup heads 121 of the sub-equipment 130a and 130b are assumed to be equal to each other. Further, the number-of-mounting-points information 307d is assumed as shown in FIG. 13.

Since the numbers of pickup nozzles 121a of the line gang pickup heads 121 of the sub-equipment 130a and 130b are equal to each other (S11 in FIG. 14), as shown in FIG. 15(a), the component arrangement determining unit 305b determines the arrangement positions for the components such that the components C, D, E and F are arranged in the component supply unit 124a and the components A and B are arranged in the component supply unit 124b (S12 in FIG. 14). That is, the numbers of mounting points for the components arranged in the component supply unit 124a and the component supply unit 124b become 100 respectively, and hence equal to each other. In this example, the component supply unit 124a is assumed to be present on the inner side of the electronic component mounting system 10. Further, the operator 200 is assumed to be located near the component supply unit 124a.

Then, the component arrangement determining unit 305b exchanges the arrangement positions for the components such that components having a larger number of mounting points are arranged as many as possible on the inner side of the electronic component mounting system 10, that is, in the component supply unit 124a (S13 in FIG. 14). FIG. 15(b) is a diagram showing the result of exchange of the arrangement positions for the components shown in FIG. 15(a). In this figure, the components arranged in the component supply unit 124a and the components arranged in the component supply unit 124b are all exchanged. Thus, the components A and B having the greatest number of mounting points are arranged in the component supply unit 124a.

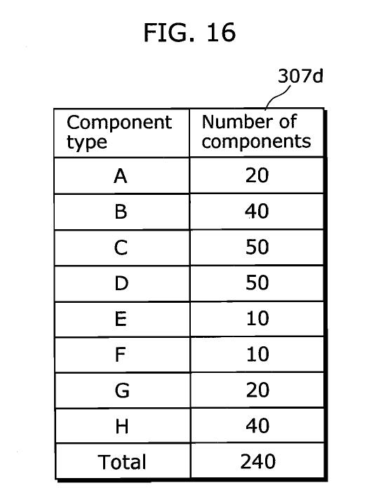

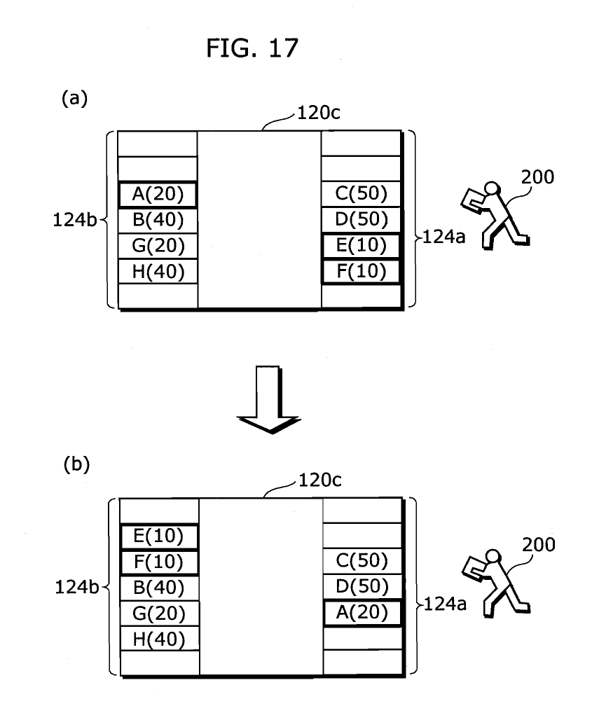

Another detailed example is described below with reference to FIGS. 16 and 17. Also in this example, similarly to the above-mentioned detailed example, the numbers of pickup nozzles 121a of the line gang pickup heads 121 of the sub-equipment 130a and 130b are assumed to be equal to each other.

FIG. 16 is a diagram showing an example of number-of-mounting-points information 307d. As shown in the figure, the component types to be mounted by the left sub-equipment 120c are eight ranging from A to H. Further, for example, the number of mounting points for the component A is 20 points, while the total number of mounting points is 240.

As shown in FIG. 17(a), the component arrangement determining unit 305b is assumed to have determined arrangement positions for the components such that the components C, D, E and F are arranged in the component supply unit 124a and the components A, B, G and H are arranged in the component supply unit 124b (S12 in FIG. 14). That is, the numbers of mounting points for the components arranged in the component supply unit 124a and the component supply unit 124b become 120 respectively, and hence equal to each other.

Then, the component arrangement determining unit 305b exchanges the arrangement positions for the components such that components having a larger number of mounting points are arranged as many as possible on the inner side of the electronic component mounting system 10, that is, in the component supply unit 124a (S13 in FIG. 14). FIG. 17(b) is a diagram showing the result of exchange of the arrangement positions for the components shown in FIG. 17(a). In this figure, the components E and F arranged in the component supply unit 124a and the component A arranged in the component supply unit 124b are exchanged. As a result, the component A having the number of mounting points of a value 20 is arranged on the inner side of the electronic component mounting system 10, while the components E and F having the number of mounting points of a value 10 are arranged on the outer side of the electronic component mounting system 10. As such, only a part of the components arranged in the component supply unit 124a and the component supply unit 124b are changed in the arranged.

Here, in place of the component A, the component G having the same number of mounting points as the component A may be arranged on the inner side. Further, the reason why the component B and the component H (having the number of mounting points of a value 40) having a greater number of mounting points than the component A are not arranged on the inner side is that if these were arranged on the inner side, the ratio between the total value of the number of mounting points for the components arranged in the component supply unit 124a and the total value of the components arranged in the component supply unit 124b would differ from the ratio of the numbers of pickup nozzles 121a acquired in the processing S11 in FIG. 14, and hence the number of tasks could not be equal in the sub-equipment 130a and in the sub-equipment 130b. If the number of tasks would differ between the sub-equipment 130a and the sub-equipment 130b, one sub-equipment would solely mount components onto the board 20, while the other sub-equipment would stop. This would degrade the working efficiency, and hence is unpreferable.

As described above, according to this embodiment, in each component mounting apparatus, after the number of tasks is equalized in two sub-equipment that mount components onto one board in a cooperated manner, component cassettes for components having a larger number of mounting points are arranged as many as possible in a component supply unit located on the inner side of the electronic component mounting system. Components having a larger number of mounting points run out frequently. Thus, when the component cassettes for such components are arranged on the inner side of the electronic component mounting system, this arrangement allows the component exchange work to be performed rapidly by the operator, and hence improves the efficiency of the component exchange work performed by the operator.

Further, the electronic component mounting system is constructed such that after components are mounted onto the front surface of a board, components are immediately mounted onto the back surface of the board. This avoids the necessity of a stocker for temporarily storing the board in which components are mounted only on the front surface. Thus, intermediate stock to be stored in such a stocker is avoided.

Here, the present embodiment has been described for the case that the sub-equipment 130a (the component supply unit 124a) of the component mounting apparatus 120 is oriented to the operator side. However, the arrangement is not limited to this. The arrangement may be such that the sub-equipment 130b (the component supply unit 124b) is oriented to the operator side.

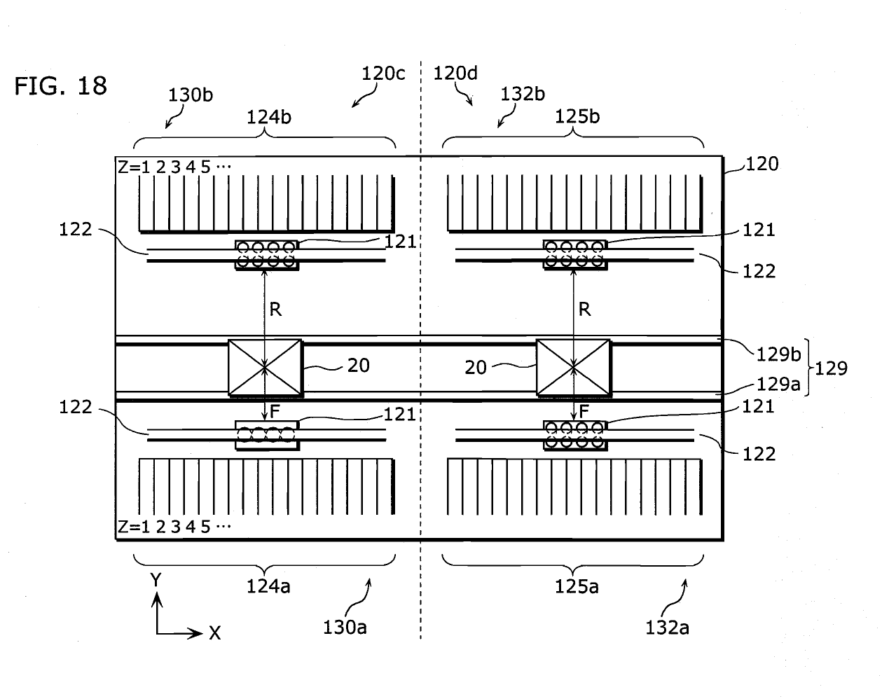

For example, the arrangement of the component mounting apparatus 120 may be determined from the positional relation between the center position of the board 20 and the normal stop position of the line gang pickup head 121. As described above, the moving rail 129b can be moved in the Y-axis direction in accordance with the length of the transported board 20 in the Y-axis direction. Thus, as shown in FIG. 18, when a board 20 of a comparatively small size is to be transferred, the moving rail 129b approaches the sub-equipment 130a side. Accordingly, when the distance in the Y-axis direction between the center position of the board 20 and the normal stop position of the line gang pickup head 121 of the sub-equipment 130a is denoted by F, and when the distance in the Y-axis direction between the center position of the board 20 and the normal stop position of the line gang pickup head 121 of the sub-equipment 130b is denoted by R, the relation “F<R” holds. That is, the board 20 is present at a position near the sub-equipment 130a rather than the sub-equipment 130b. Thus, in maintenance work performed when the line gang pickup head 121 accidentally drops a component onto a board 20 during the component mounting to the board 20 and maintenance work such as exchange of support pins that support the board 20, the operator's working efficiency is improved when the work is performed from the sub-equipment 130a side. Thus, the arrangement of the component mounting apparatus 120 may be determined such that the operator is deployed on the side where the fixed rail 129a is present.

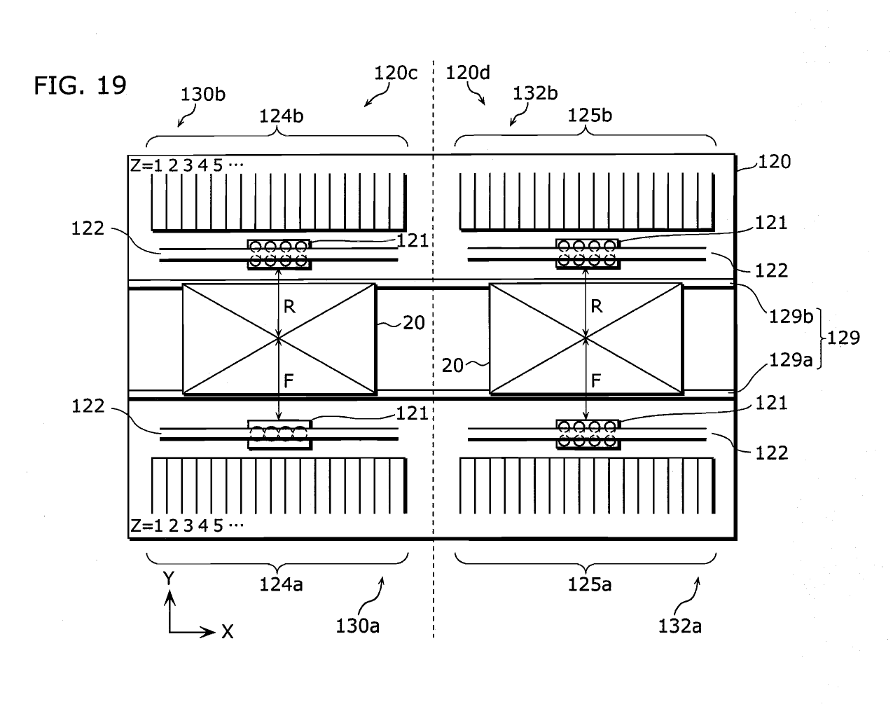

Here, as shown in FIG. 19, when a board 20 of a comparatively large size is to be transferred, the relation “F>R” holds. Thus, in this case, in order that the efficiency of the above-mentioned maintenance work should be improved, the arrangement of the component mounting apparatus 120 may be determined such that the operator is deployed on the side where the moving rail 129b is present.

Here, such arrangement determination processing for a component mounting apparatus is applicable not solely to a component mounting apparatus in which a plurality of line gang pickup heads perform coordinated operation so as to mount components onto a board. That is, this processing may be applied to a component mounting apparatus of a type that a single line gang pickup head mounts components onto a board, or alternatively to a component mounting apparatus in which a component supply unit is provided on one side only.

Further, in the production equipment arrangement determining apparatus 300 according to this embodiment, arrangement of the component cassettes has been determined such that the number of tasks is equalized in the sub-equipment 130a and in the sub-equipment 130b. However, the number of tasks need not necessarily be equalized in both sub-equipment, and the component cassettes may be arranged, with priority, in a component supply unit on the side where the operator is present. In this case, the maximum number of component cassettes that can be arranged in the component supply unit on the side where the operator is present may be arranged there, while the component cassettes that cannot be arranged in that component supply unit may solely be arranged in the component supply unit on the opposite side.

### Third Embodiment

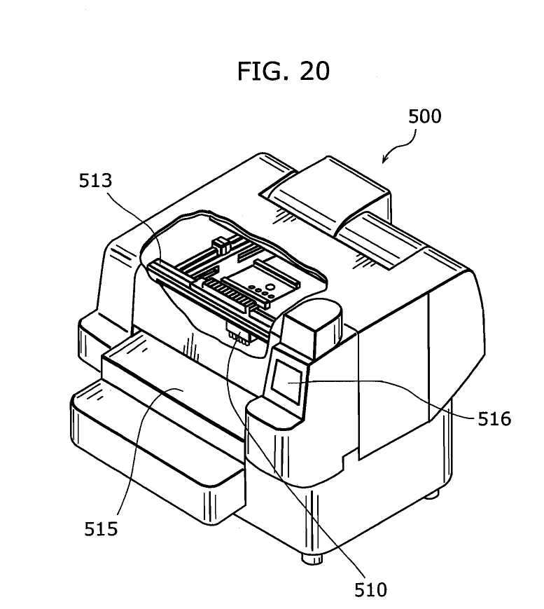

Next, a component mounting system according to a third embodiment of the present invention is described below. The electronic component mounting system according to the third embodiment has a configuration that in the electronic component mounting system 10 shown in FIGS. 1 and 2, at least one component mounting apparatus among the component mounting apparatuses 120, 140, 170 and 180 is replaced by a component mounting apparatus 500 shown in FIG. 20.

Different from the component mounting apparatus 120 and the like, in the component mounting apparatus 500, instead that two line gang pickup heads perform coordinated operation so as to mount components onto one board 20, one line gang pickup head mounts components onto one board 20. In accordance with this, the processing executed by the production equipment arrangement determining apparatus 300 differs also. Here, arrangement is assumed such that the front face of the component mounting apparatus 500 is oriented to the inner side of the electronic component mounting system.

FIG. 20 is an external appearance view of the component mounting apparatus 500 according to the third embodiment, viewed aslant from the front. In the figure, a part of the component mounting apparatus 500 is cut out so that its inside is shown.

The component mounting apparatus 500 is an apparatus that can be incorporated into a mounting line and that mounts electronic components onto a board received from the upstream and then transfers to the downstream a circuit board which is the mounting board onto which the electronic components have been mounted. The component mounting apparatus 500 includes: a line gang pickup head 510 that picks up and transports electronic components and then mounts the electronic components onto the board; an XY robot 513 that moves the line gang pickup head 510 in the horizontal plane directions; and a component supply unit 515 that supplies the components to the line gang pickup head 510. Further, in the front face of the component mounting apparatus 500, an operation unit 516 is provided for operating the component mounting apparatus 500. Also in the rear face of the component mounting apparatus 500, an operation unit (not shown) is provided.

Specifically, the component mounting apparatus 500 is a mounter that can mount onto a board various kinds of electronic components ranging from micro components to connectors, and is a mounter that can mount large-size electronic components of 10 mm square or larger, irregularly shaped components such as switches and connectors, and IC components such as a Quad Flat Package (QFP) and a Ball Grid Array (BGA).

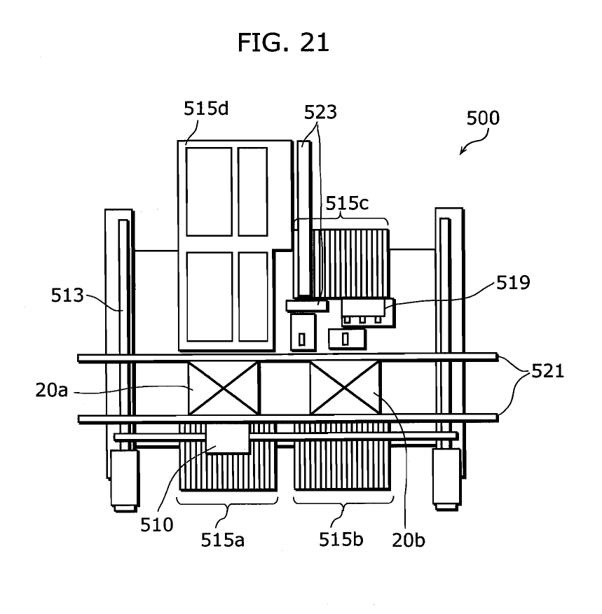

FIG. 21 is a plan view showing a major configuration of the inside of the component mounting apparatus 500.

The component mounting apparatus 500 further includes: a nozzle station 519 on which changeable nozzles are placed that are attached to the line gang pickup head 510 in an exchangeable manner so that components of various sizes may be handled; rails 521 that make up a railway for transporting two boards 20a and 20b; a mounting table (not shown) onto which the transported boards 20a and 20b are placed and electronic components are mounted thereon; and a component collecting apparatus 523 that collects a component when the electronic component having been picked up and held has a fault.

Further, the component supply units 515 are provided in the front and rear parts of the component mounting apparatus 500, and include: component supply units 515a, 515b and 515c that supply electronic components held in the form of a tape, and a component supply unit 515d that supplies electronic components held on a plate in which the components are partitioned depending on the size.

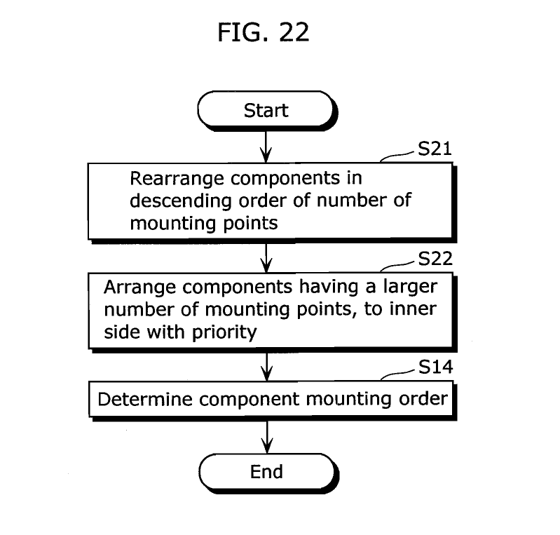

FIG. 22 is a flow chart showing determination processing for a component mounting order and component arrangement determination processing for a component supply unit which are executed for the component mounting apparatus 500 by the production equipment arrangement determining apparatus 300.

First, with reference to the number-of-mounting-points information 307d, the component arrangement determining unit 305b rearranges the components into descending order of the number of mounting points (S21). Then, the component arrangement determining unit 305b determines the arrangement positions for the components such that the components are arranged as many as possible in the component supply units 515a and 515b in the front face of the component mounting apparatus 500 (S22). At that time, arrangement positions are determined such that components having a larger number of mounting points are arranged in the component supply units 515a and 515b. Here, in the determination of arrangement positions for the components, the components not arranged in the component supply units 515a and 515b are arranged in the component supply unit 515c in the rear face of the component mounting apparatus 500.

Finally, based on the arrangement positions for the components determined by the component arrangement determining unit 305b, the mounting order determining unit 305a determines a mounting order for the components (S14). Here, as for the determining method for a mounting order for the components, various methods have been proposed in the conventional art. Thus, detailed description is not repeated here.

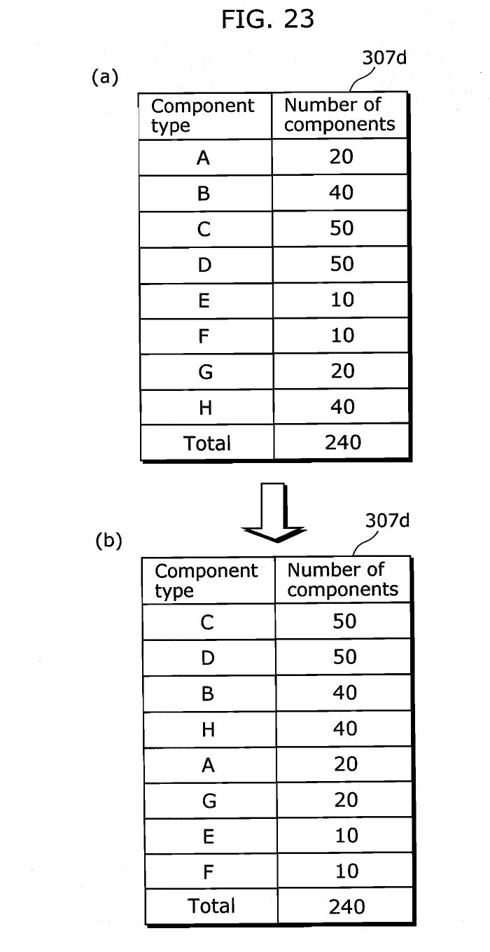

Next, with reference to a detailed example, the arrangement position determination processing (S21 and S22 in FIG. 22) for the components performed by the component arrangement determining unit 305b is described below. First, the number-of-mounting-points information 307d shown in FIG. 23(a) is assumed to be provided in advance. The number-of-mounting-points information 307d indicates number-of-mounting-points information of the components for the component mounting apparatus 500, and indicates that the component mounting apparatus 500 should mount eight types of components ranging from the component A to the component H onto one board 20. Further, the information indicates that, for example, the number of mounting points per board is 20 for the component A.

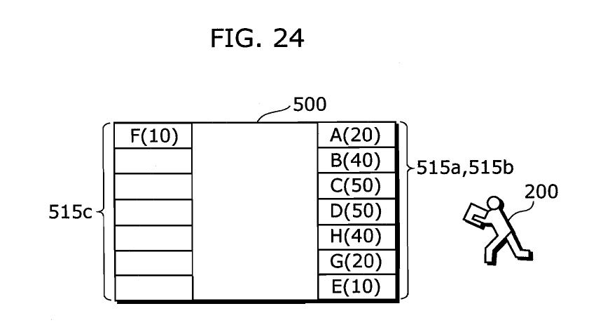

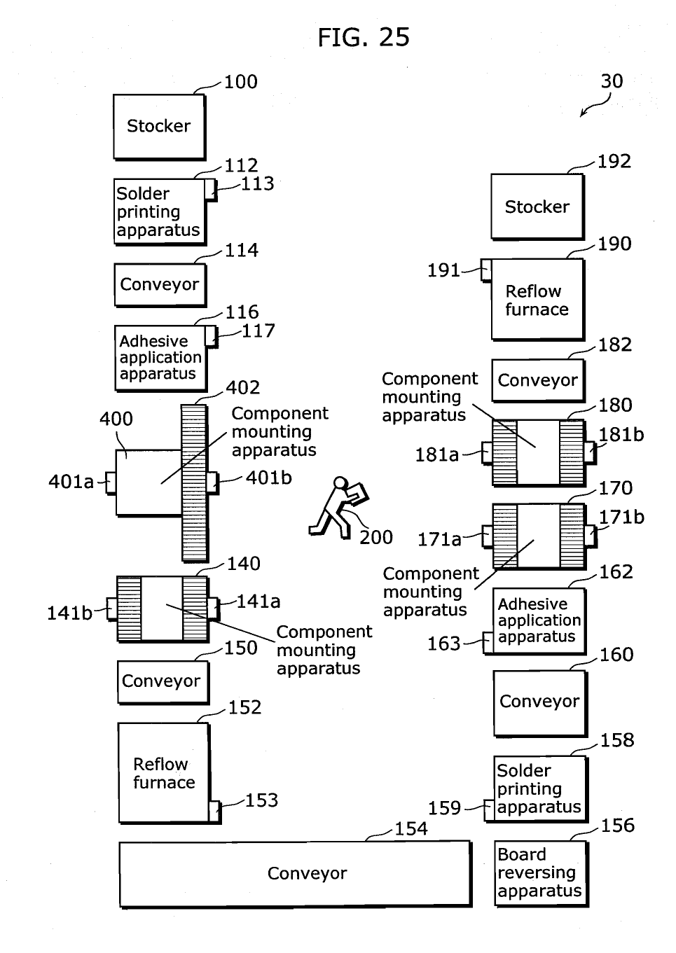

When the number-of-mounting-points information 307d shown in FIG. 23(a) is provided, the component arrangement determining unit 305b rearranges the components into descending order of the number of mounting points, and thereby generates number-of-mounting-points information 307d shown in FIG. 23(b) (S21 in FIG. 22). Then, as shown in FIG. 24, based on the number-of-mounting-points information 307d shown in FIG. 23(b), the component arrangement determining unit 305b determines the arrangement positions for the components such that the components are arranged to the component supply units 515a and 515b in descending order of the number of mounting points and then the components not arranged in the component supply units 515a and 515b, that is, the component F, are arranged in the component supply unit 515c (S22 in FIG. 22).

As described above, according to this embodiment, in each component mounting apparatus, component cassettes are arranged as many as possible in the component supply unit locate on the inner side of the electronic component mounting system. Thus, the operator can perform component exchange work without frequently going to the outer side of the electronic component mounting system. This allows the component exchange work to be performed rapidly by the operator, and hence improves the efficiency of the component exchange work performed by the operator.

Further, the component cassettes for components having a larger number of mounting points are arranged in the component supply unit on the inner side of the electronic component mounting system. Components having a larger number of mounting points run out frequently. Thus, when the component cassettes for such components are arranged on the inner side of the electronic component mounting system, this arrangement allows the component exchange work to be performed rapidly by the operator, and hence improves the efficiency of the component exchange work performed by the operator.

### Fourth Embodiment

Next, a component mounting system according to a fourth embodiment of the present invention is described below. The electronic component mounting system according to the fourth embodiment has a configuration that in the electronic component mounting system 10 shown in FIGS. 1 and 2, at least one component mounting apparatus among the component mounting apparatuses 120, 140, 170 and 180 is replaced by a component mounting apparatus 400 shown in FIG. 25.

The component mounting apparatus 400 includes: operation units 401a and 401b for operating the component mounting apparatus 400; and a component supply unit 402 for supplying components to the component mounting apparatus 400. The face where the operation unit 401a is provided is the front face of the component mounting apparatus 400, while the face where the operation unit 401b is provided is the rear face of the component mounting apparatus 400. The component supply unit 402 is provided in the rear face of the component mounting apparatus 400. The component mounting apparatus 400 is arranged such that the rear face of the component mounting apparatus 400 is oriented to the inner side of electronic component mounting system 30.

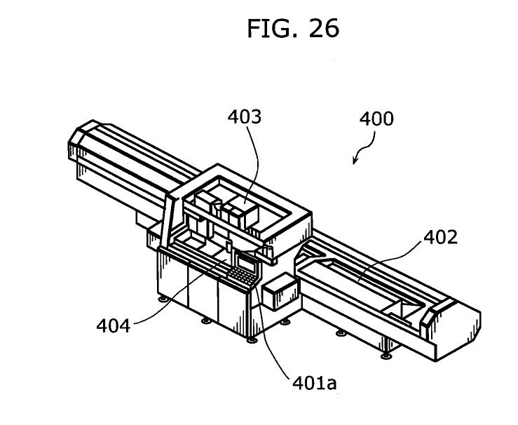

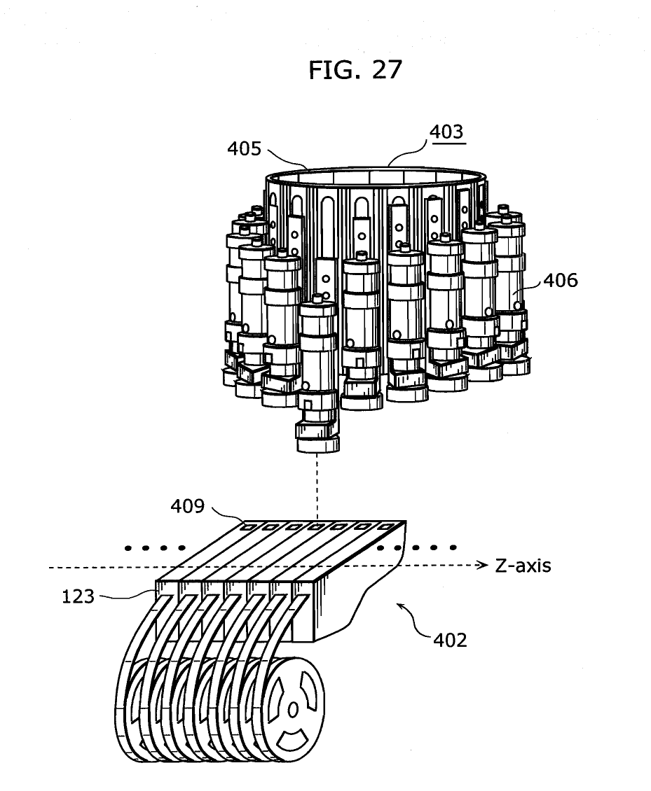

Next, with reference to FIG. 26, the component mounting apparatus 400 is described in further detail. FIG. 26 is an external appearance view of the component mounting apparatus 400 viewed aslant from the front.

The component mounting apparatus 400 is a mounting apparatus that mounts plural kinds of components at high speeds onto a printed circuit board that makes Lip an electronic apparatus. The component mounting apparatus 400 includes: a rotary head 403 that picks up, transports and mounts components; a component supply unit 402 that supplies various kinds of components to the rotary head 403; and an XY table 404 that moves, in the horizontal plane directions, a printed circuit board placed thereon.

FIG. 27 is a schematic diagram showing positional relation between a component supply unit and a rotary head.

As shown in the upper part in FIG. 27, the rotary head 403 has 18 mounting heads 406 each serving as mounting means for mounting components onto a printed circuit board. Further, the mounting head 406 has six pickup nozzles (not shown) which are attached, in a manner freely movable in the height directions, to a rotary base 405 that rotates without moving in the height directions, and that can hold components by vacuum suction.

As shown in the lower part in FIG. 27, the component supply unit 402 has component cassettes 123 that are aligned horizontally in a row and that can provide components of the same type sequentially to the mounting head 406. Then, the component supply unit 402 has the function of moving and positioning the component supply unit 402 relative to the rotary head 403 in the Z-axis directions in FIG. 27 so as to select the component to be mounted.

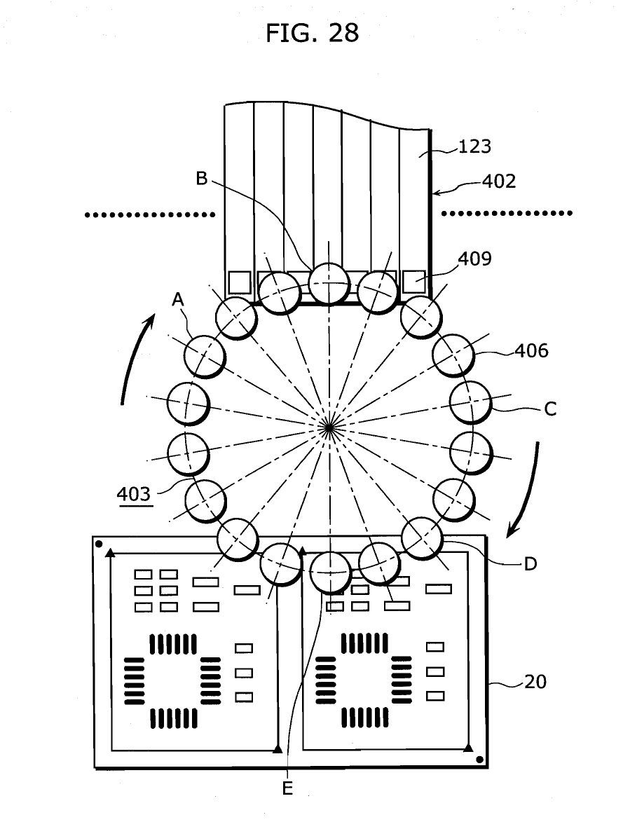

FIG. 28 is a diagram schematically showing positional relation among a rotary head, a board and a component supply unit.

As shown in the figure, the revolution axis of the rotary head 403 does not move, while the mounting head 406 provided around the revolution axis rotates intermittently about the revolution axis, so that work corresponding to each position is performed. Explained briefly, the mounting head 406 located above a pickup opening 409 (position B) provided in each component cassette 123 picks up a component through the pickup opening 409. Then, when located at the opposite position E, the mounting head 406 mounts the picked-up component onto the board 20.

Here, the board 20 onto which the components are to be mounted is placed on an XY table (not shown) that can move freely in the horizontal plane directions. The position at which the component is to be mounted is determined by moving the board 20.

As described above, according to this embodiment, in a component mounting apparatus in which component supply units are provided in one face only, the component mounting apparatus is arranged such that the component supply unit is oriented to the inner side of the electronic component mounting system. Thus, the operator can perform component exchange work without going to the outer side of the electronic component mounting system. This allows the component exchange work to be performed rapidly by the operator, and hence improves the efficiency of the component exchange work performed by the operator.

In the above, the electronic component mounting system according to an embodiment of the present invention has been described. However, the present invention is not limited to these embodiments.

For example, in the second embodiment, arrangement positions for component cassettes has been determined such that the component cassettes for components having a larger number of mounting points are arranges in a component supply unit of a component mounting apparatus located on the inner side of the electronic component mounting system. However, the arrangement positions for the component cassettes may be determined such that the component supply unit on the inner side of the electronic component mounting system should have a larger number of component cassettes.

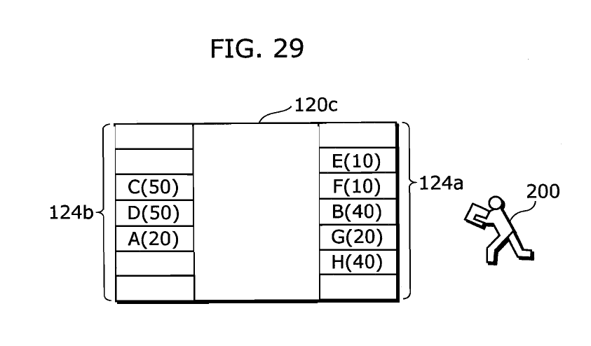

For example, in the determination processing for component arrangement (S12 in FIG. 14), when component arrangement shown in FIG. 15(a) is obtained, the component arrangement determining unit 305b determines as the optimal component arrangement the component arrangement shown in FIG. 15(a) without performing the component exchange processing (S13 in FIG. 14). Further, in the determination processing for component arrangement (S12 in FIG. 14), when component arrangement shown in FIG. 17(a) is obtained, the component arrangement determining unit 305b performs the component exchange processing (S13 in FIG. 14), and thereby determines as the optimal component arrangement, for example, the component arrangement shown in FIG. 29. By virtue of such determination, the operator can perform exchange work for a larger number of kinds of component cassettes at once.

Further, the electronic component mounting system does not necessarily have the U-shape, and may have a configuration that individual production equipment is aligned on a straight line. For example, each operator is assumed to take charge of two lines of production equipment. Further, the operator is assumed to be deployed between the two lines of charge. Then, individual production equipment is arranged such that the faces mainly operated in the two lines of charge are oriented to the side where the operator is present.

Further, the fourth embodiment has been described for the case of a component mounting apparatus referred to as a so-called rotary machine. However, the present invention is limited to a component mounting apparatus of this type. That is, the present invention is applicable also to a component mounting apparatus of another type, as long as the component mounting apparatus is of a type that a component supply unit is provided on one side only.

### INDUSTRIAL APPLICABILITY

The present invention is applicable to an electronic component mounting system that mounts components onto both surfaces of a board.

1-15. (canceled)

16. A method for determining arrangement of production equipment used in a production equipment arrangement determining apparatus which determines arrangement of a production equipment that produces a component mounting board which is a board onto which components are mounted, said method comprising:
a step of detecting a deployment position of an operator, said step being performed by the production equipment arrangement determining apparatus; and
a determining step of determining a face where the operator mainly operates the production equipment, depending on the detected deployment position of the operator, said determining step being performed by the production equipment arrangement determining apparatus.

17. The method for determining arrangement of production equipment according to claim 16,
wherein the production equipment is a component mounting apparatus which includes a plurality of component supply units and which mounts the components onto the board, and
in said determining step, arrangement of component cassettes is determined in such a way that exchanging of the component cassettes occurs more frequently in one of the component supply units which is present on a side where the operator is deployed than in other ones of the component supply units.

18. The method for determining arrangement of production equipment according to claim 16,
wherein the production equipment includes, on one side only, an operation unit for the operator to operate the production equipment, and
in said determining step, a face including the operation unit for operating the production equipment is determined as the face where the operator mainly operates the production equipment.

19. The method for determining arrangement of production equipment according to claim 16,
wherein the production equipment is a component mounting apparatus which includes a plurality of component supply units and which mounts the components onto the board, and
in said determining step, arrangement positions of component cassettes with respect to the component supply units are determined depending on the position where the operator is deployed, the component cassettes containing the components.

20. The method for determining arrangement of production equipment according to claim 19,
wherein in said determining step, the arrangement positions of the component cassettes are determined in such a way that a component cassette for components having a relatively larger number of mounting points is arranged in one of the component supply units which is on the side where the operator is deployed.

21. The method for determining arrangement of production equipment according to claim 20,
wherein the component mounting apparatus is an apparatus which includes a plurality of mounting heads that alternately mount components onto one board, and each of the plurality of component supply units is provided in the component mounting apparatus to correspond to one of the plurality of mounting heads, and
wherein said determining step includes:
a number-of-pickup-nozzles acquiring step of acquiring the number of pickup nozzles, which pick up the components, provided in each of the plurality of mounting heads, said number-of-pickup-nozzles acquiring step being performed by the production equipment arrangement determining apparatus;
an allocation step of allocating the component cassettes for to-be-mounted components to any of the plurality of component supply units in such a way that a ratio of the number of the pickup nozzles is equal to a ratio of the number of mounting points of the components onto the board, said allocation step being performed by the production equipment arrangement determining apparatus; and
an arrangement position determining step of determining, by exchanging the component cassettes between the plurality of component supply units, the arrangement positions of the component cassettes in such a way that a ratio of the number of the pickup nozzles is equal to a ratio of the number of the mounting points of components onto the board, and in such a way that a component cassette for components having a larger number of mounting points is arranged in one of the component supply units which is on the side where the operator is deployed, said arrangement position determining step being performed by the production equipment arrangement determining apparatus.

22. The method for determining arrangement of production equipment according to claim 19,
wherein in said determining step, the arrangement positions of the component cassettes are determined in such a way that the number of component cassettes is relatively greater in one of the component supply units which is on the side where the operator is deployed.

23. The method for determining arrangement of production equipment according to claim 22,
wherein the component mounting apparatus is an apparatus which includes a plurality of mounting heads which alternately mount the components onto one board, and each of the plurality of component supply units is provided in the component mounting apparatus to correspond to one of the plurality of mounting heads, and
wherein said determining step includes:
a number-of-pickup-nozzles acquiring step of acquiring the number of pickup nozzles, which pick up the components, provided in each of the plurality of mounting heads, said number-of-pickup-nozzles acquiring step being performed by the production equipment arrangement determining apparatus;
an allocation step of allocating the component cassettes for to-be-mounted components to any of the plurality of component supply units in such a way that a ratio of the number of the pickup nozzles is equal to a ratio of the number of mounting points of the components onto the board, said allocation step being performed by the production equipment arrangement determining apparatus; and
an arrangement position determining step of determining the arrangement positions of the component cassettes in such a way that the ratio of the number of the pickup nozzles is equal to the ratio of the number of the mounting points of the components onto the board and in such a way that the number of the component cassettes is relatively greater in one of the component supply units which is on the side where the operator is deployed, said arrangement position determining step being performed by the production equipment arrangement determining apparatus.

24. The method for determining arrangement of production equipment according to claim 16,
wherein the production equipment is a component mounting apparatus which includes component supply units only on one side, and which mounts the components onto the board, and
in said determining step, a face including the component supply units of the component mounting apparatus is determined as the face where the operator mainly operates the component mounting apparatus.

25. The method for determining arrangement of production equipment according to claim 16,
wherein in said determining step, the arrangement of a plurality of production equipment is further determined as a U-shape in which the operator is located in the center, while a face on an inner side of the U-shape is determined as the face where the operator mainly operates each of the production equipment.

26. A production equipment arrangement determining apparatus which determines arrangement of a production equipment that produces a component mounting board which is a board onto which components are mounted, said production equipment arrangement determining apparatus comprising:
a unit operable to detect a deployment position of an operator; and
a determining unit operable to determine a face where the operator mainly operates the production equipment, depending on the detected deployment position of the operator.

27. The production equipment arrangement determining apparatus according to claim 26,
wherein the production equipment is a component mounting apparatus which includes a plurality of component supply units, and which mounts the components onto the board, and
said determining unit is operable to determine arrangement positions of component cassettes with respect to the component supply units, depending on the position where the operator is deployed.

28. An electronic component mounting system made up of a plurality of production equipment, said system comprising
a unit operable to detect a deployment position of an operator,
wherein each production equipment is arranged in such a way that a face where the operator mainly operates the production equipment is oriented to the side of the detected deployment position of the operator.

29. A determining program which is a program for determining arrangement of a production equipment that produces a component mounting board which is a board onto which components are mounted, said program causing a computer to execute:
a step of detecting a deployment position of an operator; and
a determining step of determining a face where the operator mainly operates the production equipment, depending on the detected deployment position of the operator, said determining step being performed by the production equipment arrangement determining apparatus.
